(19) United States
(12) Patent Application Publication
(10) Pub. No.: US 2024/0427326 A1
(43) Pub. Date: Dec. 26, 2024

(54) SHARING UAV FLIGHT DATA WITH REMOTE OBSERVERS

(71) Applicant: NATIONAL RESEARCH COUNCIL OF CANADA, Ottawa (CA)

(72) Inventor: Jean-Francois LAPOINTE, Gatineau (CA)

(21) Appl. No.: 18/213,377

(22) Filed: Jun. 23, 2023

(51) Int. Cl. G05D 1/00; B64U 10/10; G08G 5/00

(52) U.S. Cl. CPC G05D 1/0038; B64U 10/10; G08G 5/0069; B64U 2101/26; B64U 2201/20

(57) ABSTRACT

A graphical user interface is generated with flight data of an unmanned aerial vehicle that is controllable by a surface-based pilot with a remote control. The graphical user interface is outputted to an observer computing device that is remote from the surface-based pilot. The graphical user interface provides the flight data to an observer at the observer computing device. Flight data may include video, flight parameters, geographic location, and similar data to facilitate a task carried out by the pilot and the remote observer, such as the inspection of infrastructure.

### FIELD

The present disclosure related to unmanned aerial vehicles and drones.

### BACKGROUND

Unmanned aerial vehicles or drones are useful for flights that do not require an onboard human pilot or passengers. Such vehicles may be used for photography, videography, inspection, delivery, among other uses. A pilot who remains on the ground may control the flight while watching the vehicle in the sky.

### SUMMARY

According to an aspect of the present disclosure, a non-transitory machine-readable medium includes instructions that, when executed by one or more processors, cause the one or more processors to collectively receive flight data of an unmanned aerial vehicle that is controllable by a surface-based pilot with a remote control, generate a graphical user interface with the flight data, output the graphical user interface to an observer computing device that is remote from the surface-based pilot with the remote control. The graphical user interface provides the flight data to an observer at the observer computing device.

The flight data may include video captured by a camera of the unmanned aerial vehicle, and the instructions may further display the video within the graphical user interface.

The flight data may include a geographic position of the unmanned aerial vehicle, and the instructions may further display the geographic position of the unmanned aerial vehicle on a map within the graphical user interface.

The flight data may include video captured by a camera of the unmanned aerial vehicle, a geographic position of the unmanned aerial vehicle, and an altitude of the unmanned aerial vehicle. The instructions may further display within the graphical user interface the video, a map with the geographic position of the unmanned aerial vehicle, and the altitude of the unmanned aerial vehicle.

The instructions may further receive feedback data from the observer computing device and output the feedback data to the surface-based pilot or the unmanned aerial vehicle.

The feedback data may include a digitized voice of the observer at the observer computing device.

The feedback data may include a command to control a camera of the unmanned aerial vehicle.

The flight data may include an altitude of the unmanned aerial vehicle, a pitch of the unmanned aerial vehicle, a roll of the unmanned aerial vehicle, a yaw of the unmanned aerial vehicle, a latitude of the unmanned aerial vehicle, a longitude of the unmanned aerial vehicle, or a combination of such.

The graphical user interface may be configured for inspection of infrastructure by the observer at the observer computing device.

The instructions may further display a three-dimensional model of the infrastructure within the graphical user interface.

According to another aspect of the present disclosure, a device includes a communications interface and one or more processors connected to the communications interface. The one or more processors configured collectively receive, via the communications interface, flight data of an unmanned aerial vehicle that is controllable by a surface-based pilot with a remote control, generate a graphical user interface with the flight data, and provide, via the communications interface, the graphical user interface to an observer computing device that is remote from the surface-based pilot with the remote control. The graphical user interface provides the flight data to an observer at the observer computing device.

The flight data may include video captured by a camera of the unmanned aerial vehicle, and the graphical user interface may display the video.

The flight data may include a geographic position of the unmanned aerial vehicle, and the graphical user interface may display the geographic position of the unmanned aerial vehicle on a map.

The flight data may include video captured by a camera of the unmanned aerial vehicle, a geographic position of the unmanned aerial vehicle, and an altitude of the unmanned aerial vehicle. The graphical user interface may display the video, a map with the geographic position of the unmanned aerial vehicle, and the altitude of the unmanned aerial vehicle.

The one or more processors may be further configured to collectively receive, from the observer computing device via the communications interface, digitized voice of the observer at the observer computing device, and output the digitized voice of the observer to the surface-based pilot.

The one or more processors may be further configured to collectively receive, from the observer computing device via the communications interface, a command to control a camera of the unmanned aerial vehicle, and output the command to control a camera to the surface-based pilot or the unmanned aerial vehicle.

The graphical user interface may be configured for inspection of infrastructure by the observer at the observer computing device.

According to another aspect of the present disclosure, a method includes receiving flight data of an unmanned aerial vehicle that is controllable by a surface-based pilot with a remote control, generating a graphical user interface with the flight data, and outputting the graphical user interface to an observer computing device that is remote from the surface-based pilot with the remote control. The graphical user interface provides the flight data to an observer at the observer computing device.

The flight data may include video captured by a camera of the unmanned aerial vehicle and a position of the unmanned aerial vehicle. The method may further include displaying the video and the position of the unmanned aerial vehicle within the graphical user interface.

The method may further include receiving feedback data from the observer computing device, and outputting the feedback data to the surface-based pilot or the unmanned aerial vehicle.

### BRIEF DESCRIPTION OF THE FIGURES

FIG. 1 is a diagram of an example system that includes an unmanned aerial vehicle, an observer computing device, and a graphical user interface provided to the observer computing device and configured to provide flight data of the unmanned aerial vehicle to a remote observer.

FIG. 2 is a block diagram of an example computing device configured to generate a graphical user interface with flight data.

FIG. 3 is a flowchart of an example method of providing a graphical user interface with flight data of an unmanned aerial vehicle to an observer computing device.

FIG. 4 is a flowchart of an example method of providing a graphical user interface with flight data of an unmanned aerial vehicle to an observer computing device, in which feedback may be provided by the observer computing device.

FIG. 5 is a diagram of an example graphical user interface with flight data of a UAV.

FIG. 6 is a data flow diagram of an example graphical user interface with flight data of a UAV.

### DETAILED DESCRIPTION

Unmanned aerial vehicle (UAVs) may be used for many tasks. It is often the case that multiple people need to be at the location of the UAV to complete a task. For example, in the case of infrastructure inspection, a pilot needs to be present to fly the UAV and one or more inspectors, who may be experts in structural engineering, civil engineering, corrosion, or similar fields, need to be present as well to view and evaluate the data captured by the UAV. While it may be possible for an expert to review captured data after the flight, and thus not have to travel to the inspection site, this does not allow the expert to provide input during the inspection. As such, it is common practice for multiple people to visit an inspection site and it is sometimes required for people to return the site for follow up.

This disclosure provides techniques to generate and share a graphical user interface (GUI) that allows observers distant from a site where a UAV is flown to view flight data and provide feedback. Only the UAV pilot need travel to the site. Any number of observers, such as inspectors or experts, may use a computer that is convenient to them to view flight data and interact with the pilot and/or UAV. This allows for tasks, such as infrastructure inspection, to be carried out in a more efficient manner. The inconvenience, time, and pollution associated with multiple people visiting a site may also be reduced.

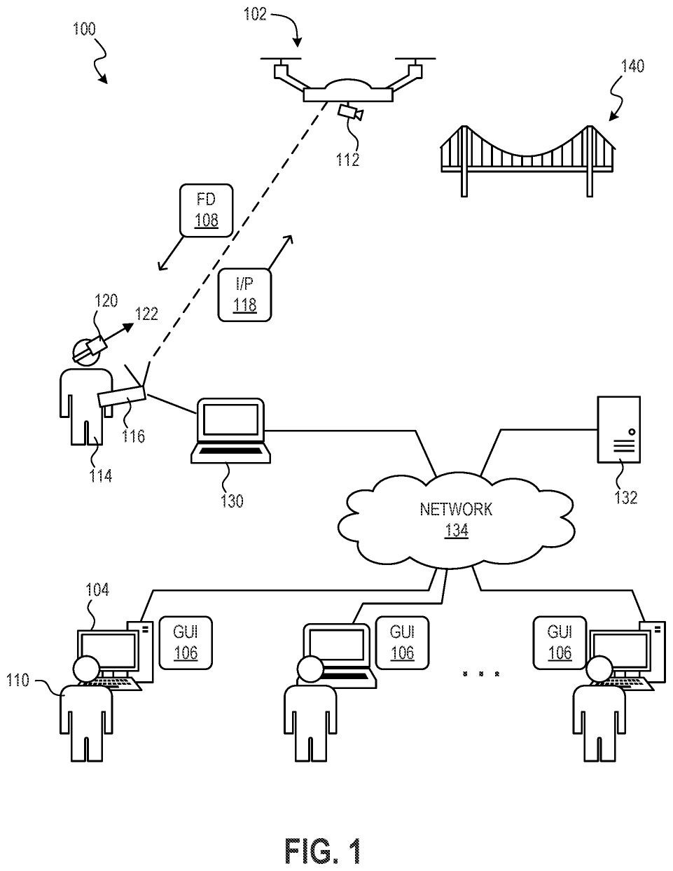

FIG. 1 shows an example system 100 that includes a UAV 102, an observer computing device 104, and a GUI 106 provided to the observer computing device 104 and configured to provide flight data 108 of the UAV 102 to a remote observer 110. The GUI 106 allows an observer, such as an inspector, to view the flight data 108 while being remote from the location of the UAV 102 and its pilot 114.

The UAV 102 includes an airframe, a set of rotors, a power source, a wireless communications interface, and a controller configured for human-controlled or semi-autonomous flight. The UAV 102 may include additional components, such as a camera 112, which may be fixed or aimable. The camera 112 may capture digital video from the perspective of the UAV 102. Alternatively or additionally, the camera 112 or an array of cameras 112 may obtain digital video with a bird's eyes view of the UAV 102. The UAV 102 may be referred to as a drone.

The UAV 102 may be flown by a surface-based pilot 114 with a remote control 116. The surface-based pilot 114 may be positioned on a surface, such as the ground or the surface of a body of water, or may be positioned on a structure or vehicle on such a surface, such as a truck bed, boat, rooftop, or similar. In the example of infrastructure inspection, it should be appreciated that the pilot 114 may be situated on a wide variety of surfaces that provide a vantage point to the part of the infrastructure under inspection. Input signals 118 to control the flight of the UAV 102 may be wirelessly transmitted to the UAV 102 by the remote control 116. The pilot 114 may additionally or alternatively use an alternate reality (AR) headset 120 to aid the flying of the UAV 102.

The headset 120 may include a housing, a communications interface, a display device, a non-transitory machine-readable medium, and one or more processors. The headset 120 may be a commercially available AR headset. The headset 120 may include a transparent screen or other type of optical look-through device that provides an optical real view 122. Optical look-through may be directly through the screen or aided by optical components, such as a lens, mirror, etc. Alternatively, the real view 122 may be captured by a camera installed at the headset 120 aimed in the direction of the wearer's view and rendered to the wearer with a display device.

The system 100 further includes a computing device to generate the GUI 106 with flight data 108 and carry out related functions, as discussed herein. Such a GUI-providing computing device may be at the same location as the pilot 114. For example, the GUI-providing computing device may be a portable computer 130 (e.g., notebook computer, smartphone, etc.) operated by the pilot 114 and connected to the remote control 116 or to the UAV 102 to obtain flight data 108. Alternatively, the GUI-providing computing device may be the remote control 116 itself, if the remote control 116 is provided with sufficient processing functionality. In another example, the GUI-providing computing device may be a server 132 that is located remote from the pilot 114. The server 132 may connect, via a network 134, to a portable computer 130 operated by the pilot or to the remote control 116 itself, if the remote control 116 is configured with network connectivity, to obtain flight data 108.

The following description references this last example of a server 132 connected to a portable computer 130 operated by the pilot 114, where the portable computer 130 obtains flight data 108 of the UAV 102 from the remote control 116 or from the UAV 102 directly. It should be understood that, in other examples, functionality attributed to the server 132 may be implemented by the portable computer 130, remote control 116, or other capable computing device. Further, any combination of a server 132, portable computer 130, and remote control 116 may cooperate to collectively perform the functionality discussed herein. In addition, the server 132 may include multiple servers at the same or different locations that cooperate.

The server 132 is configured to receive flight data 108. This may be done by the portable computer 130 connecting to the remote control 116, in a wired or wireless manner, and/or the UAV 102, in a wireless manner, to obtain flight data 108. The portable computer 130 also connects to the server 132, via the network 134, and provides the flight data 108 to the server 132. The network 134 may include wireless or wired components or both. The network 134 may include the internet, a local-area network (LAN), a wide-area network (WAN), a virtual private network (VPN), and so on. In various examples, the portable computer 130 connects to the server 132 via a wireless cellular network and the internet.

The server 132 is configured to generate the GUI 106 with the flight data 108. The server 132 may be a webserver that is configured to generate a webpage that contains the flight data 108. The portable computer 130 may post flight data 108 to the server 132.

The server 132 is configured to output the GUI 106 with the flight data 108 to a connected observer computing device 104 operated by an observer 110 distant from the surface-based pilot 114 and UAV 102. For example, the server 132 may respond to requests (e.g., HTTP or HTTPS requests) with code that, when executed by the observer computing device 104, renders the GUI 106 with the flight data 108. Alternatively, the GUI 106 with the flight data 108 are rendered by the server 132 and images are communicated to and displayed at the observer computing device 104. Any suitable number of observer computing devices 104 may connect to the server 132 to obtain the GUI 106 and flight data 108 in this way.

As such, observers 110 may view the flight data 108 without having to travel to the location of the surface-based pilot 114 and UAV 102. Observers 110 may have special expertise that may be helpful in the task being performed by the surface-based pilot 114 and UAV 102, such as the inspection of physical infrastructure 140 (e.g., bridges, tunnels, towers, wind turbines, mine shafts, navigation buoys, etc.). According, the cost and time required to perform inspections may be significantly reduced.

Flight data 108 may include a geographic position (e.g., latitude and longitude) of the UAV 102 as measured by a global-positioning device on the UAV, video captured by the UAV 102, or flight parameters, such as altitude, velocity, pitch, roll, and yaw. Any combination of such flight data 108 may be provided to the GUI. Flight data 108 may be selected to facilitate the task expected of an observer 110.

The GUI 106 may be configured to facilitate the task expected of the observer 110. As will be discussed in detail below, flight data 108 may be arranged and presented in a way that is conducive to the observer 110 performing their task, such as infrastructure inspection. Video captured by the UAV is particularly useful for inspection. UAV-captured video may be augmented to include an AR overlay that highlights regions of the infrastructure for closer human review, which may be determined using artificial intelligence (AI) techniques to process the video.

The GUI 106 may be further configured to provide feedback to the pilot 114 or the UAV 102.

The GUI 106 may capture and digitize the voice of the observer 110 and transmit such to portable computer 130 via the server 132 and network 134. The portable computer 130, or a device connected thereto, may output the voice to the pilot 114, so that the pilot 114 may hear what the observer 110 wishes to communicate. For example, the observer 110 may request that the UAV 102 be operated in a specific manner, such as by increasing or decreasing altitude, changing orientation or position, aiming the UAV's camera 112, and so on.

In another example of observer feedback, the GUI 106 may capture a command from the observer 110, such as a mouse click or keyboard key press, to control the camera 112 of the UAV 102. The command may be transmitted to the portable computer 130 via the server 132 and network 134. The portable computer 130, being connected to the remote control 116 or UAV 102, may then issue the command so as to aim the camera 112 accordingly. Such a command may be provided to the UAV 102 as an input signal 118.

Accordingly, an observer 110 may view the flight data 108 and also interact with the pilot 114 and/or UAV 102. This may further increase the effectiveness of the observer 110 in performing their task. For example, an infrastructure inspector may verbally direct the pilot 114 to fly the UAV 102 to a certain part of the piece of infrastructure that the observer 110 wishes to see more closely.

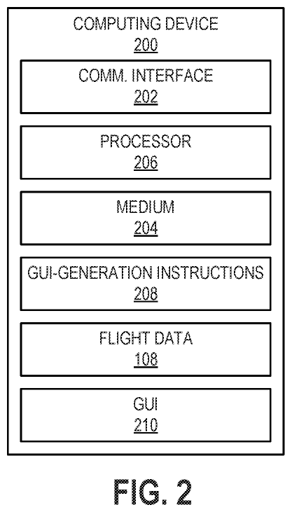

FIG. 2 shows an example computing device 200 configured to generate a GUI with flight data. The computing device 200 may be used as the server 132 discussed above or, in other examples, as the portable computer 130 or remote control 116.

The computing device 200 includes a communications interface 202, a non-transitory machine-readable medium 204, and one or more processors 206.

The communications interface 202 includes hardware, such as a network adaptor card, network interface controller, or network-capable chipset, and may further include instructions, such as a driver and/or firmware.

The non-transitory machine-readable medium 204 may include an electronic, magnetic, optical, or other physical storage device that encodes instructions. The medium 204 may include, for example, random access memory (RAM), read-only memory (ROM), electrically-erasable programmable read-only memory (EEPROM), a field-programmable gate array (FPGA) flash memory, a storage drive, an optical device, or similar. The medium 204 may include non-volatile memory, volatile memory, or a combination of such.

The non-transitory machine-readable medium 204 stores instructions that, when executed by one or more processors 206, cause the one or more processors 206 to collectively perform the functionality discussed herein.

The one or more processors 206 includes a central processing unit (CPU), a microprocessor, a processing core, an FPGA (e.g., the processor and medium may be the same device), an application-specific integrated circuit (ASIC), or a similar device capable of executing the instructions. The terms “a” and “the” processor, as used herein, mean one or more processors that collectively execute instructions. “One or more processors” will be referred to as “the processor” for sake of brevity. When multiple processors are used, one process may execute some instructions and another processor may execute other, different instructions.

The processor 206 is connected to the communications interface 202 and the non-transitory machine-readable medium 204.

GUI-generation instructions 208 are provided to carry out the functionality discussed herein. Instructions 208 may be directly executed, such as a binary file, and/or may include interpretable code, bytecode, source code, or similar instructions that may undergo additional processing to be executed.

The GUI-generation instructions 208 obtain flight data 108 via the communications interface 202 and generate a GUI 210 with the flight data 108. The GUI 210 is not displayed at the computing device 200 and may thus include code that is not yet executed. The GUI-generation instructions 208 output the GUI 210 via the communications interface 202 to any observer computing devices that that request the GUI 210. The GUI 210 may then be rendered at the observer computing device. Alternatively, the GUI 210 may take the form of a sequence of images or a video stream that is transmitted to the observer computing device for display. In either case, the content of the GUI 210 may be the same.

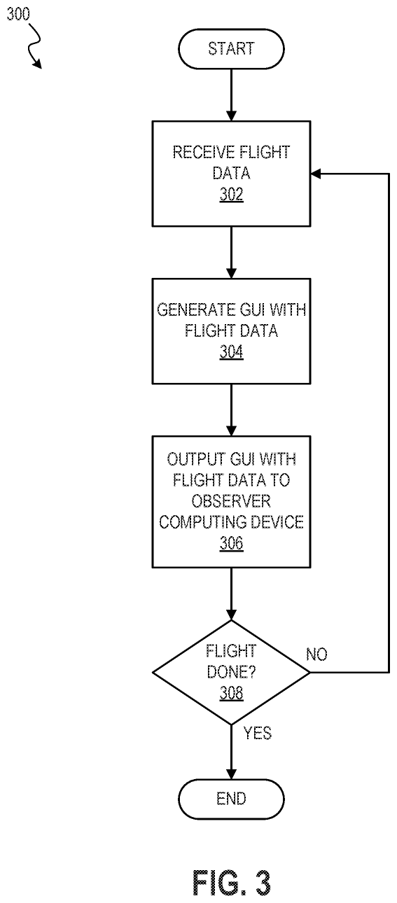

FIG. 3 shows an example method 300 of providing a GUI with flight data of a UAV to an observer computing device. The above discussion of the system 100 and device 200 may be referenced for details not repeated here. The method 300 may be implemented as instructions that are stored at a machine-readable medium and executed by a processor.

At block 302, flight data of a UAV is received at a computing device. Flight data may be received directly from the UAV when the computing device is on site with the UAV. Alternatively, flight data may be received indirectly, such as via a computer network, when the computing device is distant from the site where the UAV is being flown. Flight data may include video captured by a camera of the UAV, a position of the UAV, and/or flight parameters, such as altitude, velocity, pitch, roll, and yaw.

At block 304, a GUI with the flight data is generated. The GUI is configured to present the flight data to an observer who is expected to be remote from the site of the UAV flight and not flying the UAV. The GUI may be generated as code (e.g., HTML and JavaScript) that renders a webpage.

At block 306, the GUI is outputted to the observer's computing device, so that the observer may view and interact with the flight data. This may include transmitting the code to the observer's computing device, which may render and display the GUI to the observer. Video captured by a camera of the UAV, a position of the UAV, and/or flight parameters, such as altitude, velocity, pitch, roll, and yaw, may thus be viewed and considered by the observer.

The observer may thus view the video and/or consider the other flight data to carry out their portion of the task. This enables, for example, remote visual inspection of physical infrastructure.

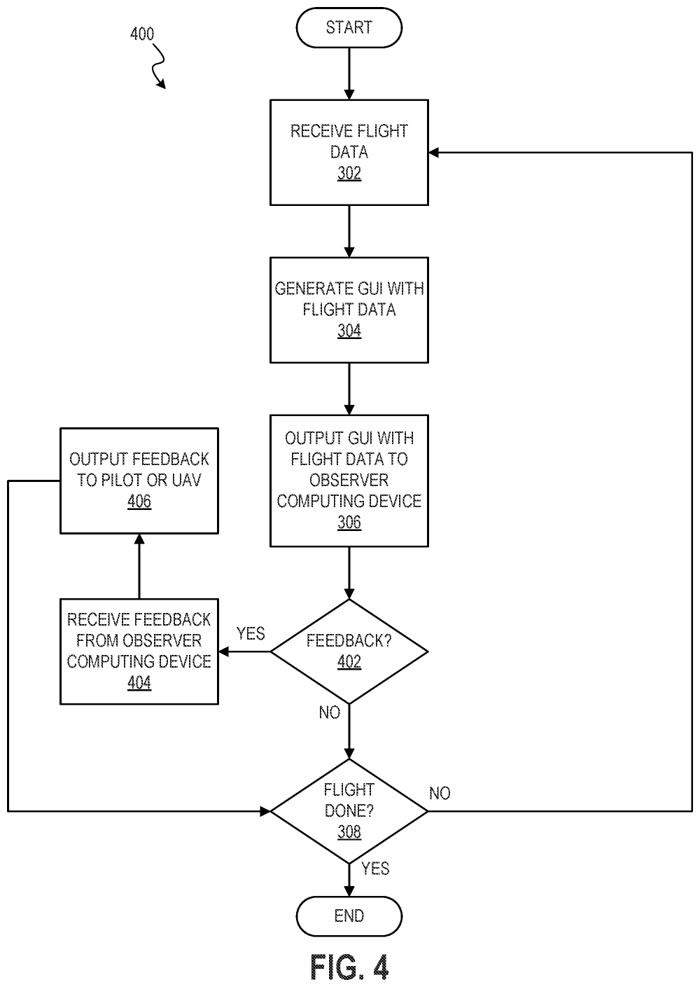

FIG. 4 shows an example method 400 of providing a GUI with flight data of a UAV to an observer computing device, in which feedback may be provided by the observer computing device. The above discussion of the system 100, device 200, and method 300 may be referenced for details not repeated here. The method 400 may be implemented as instructions that are stored at a machine-readable medium and executed by a processor.

The method 400 receives flight data, generates a GUI with the flight data, and output the GUI with flight data to the observer, at blocks 302-306, as discussed above.

At block 402, it is determined whether the observer has any feedback regarding the flight data. The observer may press a button, click their mouse, speak, or take other action with the GUI to signal feedback.

At block 404, feedback data is received from the observer via the GUI. This may include the capture of the observer's voice, the capture of a command, the capture of a message, or similar. An example command may allow the observer to control the camera at the UAV, for example, by aiming the camera with its gimbal.

At block 406, the feedback data is provided to the pilot or the UAV, as the case may be. Digitized voice may be outputted by a speaker in the vicinity of the pilot. A message may be displayed to the pilot. A command may be issued to the UAV, with or without confirmation from the pilot.

The observer may thus view the video and/or consider the other flight data to carry out their portion of the task, and further may provide feedback to the pilot or UAV to assist or guide execution of the task. This enables, for example, remote visual inspection of physical infrastructure with interaction by remote inspectors.

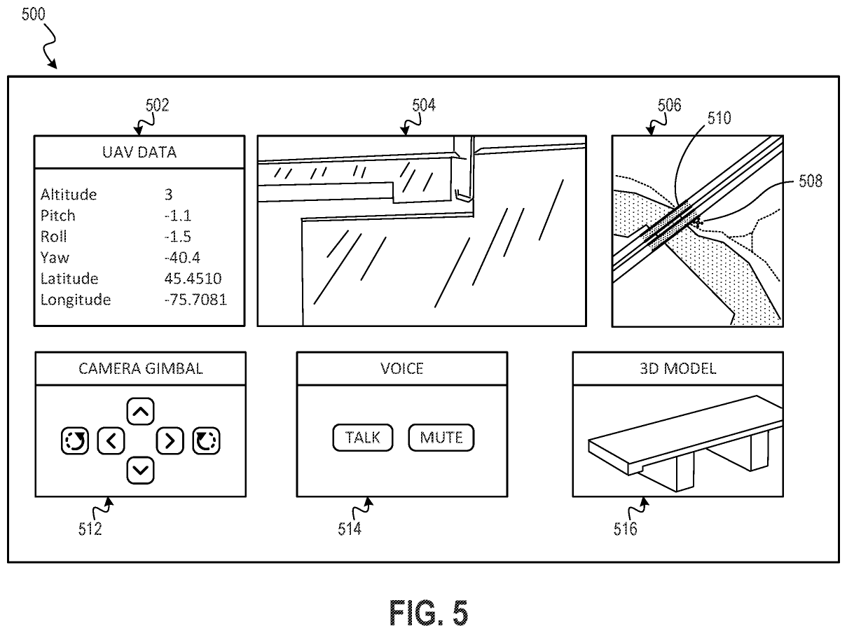

FIG. 5 shows an example GUI 500 with flight data of a UAV, which may be used with the system 100, device 200, and methods 300, 400 discussed above. The GUI 500 may be implemented as instructions or code stored at a machine-readable medium and executed by a processor to render the GUI 500 as shown.

The GUI 500 includes a data element 502, a video element 504, and a map element 506.

The data element 502 may include text fields with labels for flight parameters, such as altitude, pitch, roll, and yaw, and/or for geographic location data, such as latitude and longitude coordinates. This information may help an inspector understand how the UAV is situated with respect the infrastructure under inspection. For example, the UAV's altitude may help the inspector understand which part of the infrastructure is currently being viewed.

The video element 504 may include a video stream captured by the camera of the UAV. In the case of infrastructure inspection, the inspector viewing the GUI 500 may use the video to conduct a visual inspection related to structural integrity, damage, wear, corrosion, etc. of the infrastructure.

The map element 506 may display a map of the location of the flight. The map may be obtained from a publicly available map source. The geographic coordinates of the UAV may be provided to the map source, which may respond with a map. The precise location of the UAV on the map may be indicated by a marker 508. This may help the observer better understand the location of the UAV relative to the infrastructure, such as bridge 510, which may provide greater context to better understand the video provided in the video element 504.

In implementations that use feedback, the GUI 500 may further include a camera control element 512, a voice element 514, or both.

The camera control element 512 may provide buttons or other control elements to allow the observer to input a command to control the camera of the UAV. Such commands may be configured to pan, zoom, and/or rotate the camera about various axes.

The voice element 514 may include a voice capture element and buttons that control the voice capture element. The voice capture element (not shown) may cooperate with a microphone of the observer computing device to capture and digitize the voice of the observer. Various libraries and/or application programming interfaces (APIs) may be used to capture and digitize voice via a webpage or similar GUI framework. The buttons may control the voice capture element by, for example, activating it (“Talk”) and deactivating it (“Mute”). The voice element 514 may provide for two- or multi-way voice communications, so that the pilot and any suitable number of observers may talk despite their different locations. Accordingly, the voice element 514 may also connect to the speaker or headset of the observer computing device.

The GUI 500 may further include a three-dimensional (3D) model element 516 to display a 3D model of the piece of infrastructure under inspection. The 3D model may be fetched from a repository of 3D models. The 3D model may provide additional information to the inspector concerning the inspection.

As can be seen, the GUI 500 provides a useful arrangement of various UAV flight data for reference by an observer who is remote from the UAV. The flight data may be presented in a manner that facilities efficient performance of the task at hand, such as infrastructure inspection. Other data, such as map data or a 3D model may be provided in the GUI 500 to give further context to the task. In addition, the GUI 500 may provide an efficient way of providing feedback to the pilot or the UAV during the performance of the task.

In other examples, the GUI may include more or fewer components than those depicted.

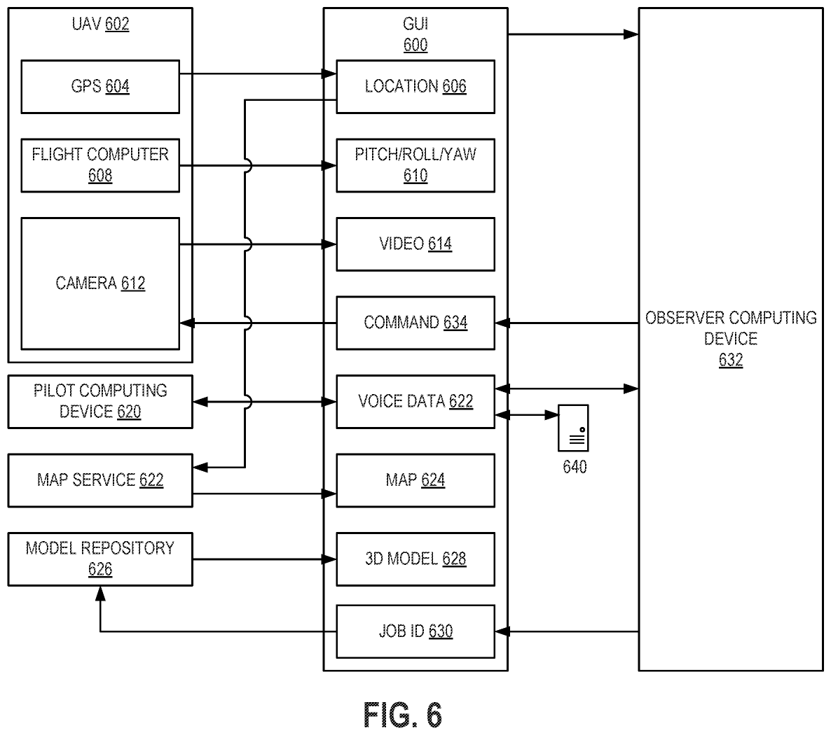

FIG. 6 shows an example data flow for a GUI 600 using the techniques discussed above.

A UAV 602 may include a GPS device 604 that determines a geographic location 606 of the UAV 602. The UAV 602 may include a flight computer 608 that determines flight parameters, such as pitch, roll, and yaw 610. The location 606 and pitch, roll, and yaw 610 may be obtained directly from the UAV 602 or may be obtained from a remote control of the UAV 602. The UAV 602 may include a camera 612 that captures video 614.

A pilot computing device 620, such as an AR headset, smartphone, portable computer, or the UAV remote control may capture and digitize the voice of the pilot to obtain voice data 622.

A map service 622, such as OpenStreetMap™, may provide a map 624 based on an inputted location 606, which may be received from the GUI 600.

A model repository may provide a 3D model 628, which may be looked up based on a job number 630 or similar identifier obtained via the GUI 600.

The GUI 600 may display the location 606, pitch/roll/yaw 610, video 614, map 624, and 3D model 628 at an observer computing device 632.

The observer computing device 632 may provide via the GUI 600 a command 634 to control the camera 612 of the UAV 602.

The observer computing device 632 may capture and digitize the voice of the observer to obtain voice data 622. Voice data 622 may be captured and played in a manner similar to a conference system (e.g., Zoom™). Any suitable number of participants may provide voice data 622 to facilitate a conversation among the pilot and observer(s). This may involve the use of a voice conference server 640.

The observer computing device 632 may provide a job ID 630 to the GUI 600 to facilitate the GUI obtaining a relevant 3D model 628 from the model repository 626.

In view of the above, it should be apparent that the techniques discussed herein provide for the efficient sharing of UAV flight data with remote observers as well as the sharing of feedback by the remote observers to the pilot or UAV. As such, UAV-facilitated tasks, such as the inspection of infrastructure, may be made more efficient, in that fewer people need to travel to the location of interest.

It should be recognized that features and aspects of the various examples provided above can be combined into further examples that also fall within the scope of the present disclosure. In addition, the figures are not to scale and may have size and shape exaggerated for illustrative purposes.

1. A non-transitory machine-readable medium comprising instructions that, when executed by one or more processors, cause the one or more processors to collectively:
receive flight data of an unmanned aerial vehicle that is controllable by a surface-based pilot with a remote control;
generate a graphical user interface with the flight data; and
output the graphical user interface to an observer computing device that is remote from the surface-based pilot with the remote control, wherein the graphical user interface provides the flight data to an observer at the observer computing device.

2. The non-transitory machine-readable medium of claim 1, wherein:
the flight data comprises video captured by a camera of the unmanned aerial vehicle; and
the instructions are further to display the video within the graphical user interface.

3. The non-transitory machine-readable medium of claim 1, wherein:
the flight data comprises a geographic position of the unmanned aerial vehicle; and
the instructions are further to display the geographic position of the unmanned aerial vehicle on a map within the graphical user interface.

4. The non-transitory machine-readable medium of claim 1, wherein:
the flight data comprises video captured by a camera of the unmanned aerial vehicle, a geographic position of the unmanned aerial vehicle, and an altitude of the unmanned aerial vehicle; and
the instructions are further to display within the graphical user interface the video, a map with the geographic position of the unmanned aerial vehicle, and the altitude of the unmanned aerial vehicle.

5. The non-transitory machine-readable medium of claim 1, wherein the instructions are further to:
receive feedback data from the observer computing device; and
output the feedback data to the surface-based pilot or the unmanned aerial vehicle.

6. The non-transitory machine-readable medium of claim 5, wherein the feedback data comprises a digitized voice of the observer at the observer computing device.

7. The non-transitory machine-readable medium of claim 5, wherein the feedback data comprises a command to control a camera of the unmanned aerial vehicle.

8. The non-transitory machine-readable medium of claim 1, wherein the flight data comprises:
an altitude of the unmanned aerial vehicle;
a pitch of the unmanned aerial vehicle;
a roll of the unmanned aerial vehicle;
a yaw of the unmanned aerial vehicle;
a latitude of the unmanned aerial vehicle;
a longitude of the unmanned aerial vehicle; or
a combination of such.

9. The non-transitory machine-readable medium of claim 1, wherein the graphical user interface is configured for inspection of infrastructure by the observer at the observer computing device.

10. The non-transitory machine-readable medium of claim 9, wherein the instructions are further to display a three-dimensional model of the infrastructure within the graphical user interface.

11. A device comprising:
a communications interface;
one or more processors connected to the communications interface, the one or more processors configured to collectively:
receive, via the communications interface, flight data of an unmanned aerial vehicle that is controllable by a surface-based pilot with a remote control;
generate a graphical user interface with the flight data; and
provide, via the communications interface, the graphical user interface to an observer computing device that is remote from the surface-based pilot with the remote control, wherein the graphical user interface provides the flight data to an observer at the observer computing device.

12. The device of claim 11, wherein:
the flight data comprises video captured by a camera of the unmanned aerial vehicle; and
the graphical user interface displays the video.

13. The device of claim 11, wherein:
the flight data comprises a geographic position of the unmanned aerial vehicle; and
the graphical user interface displays the geographic position of the unmanned aerial vehicle on a map.

14. The device of claim 11, wherein:
the flight data comprises video captured by a camera of the unmanned aerial vehicle, a geographic position of the unmanned aerial vehicle, and an altitude of the unmanned aerial vehicle; and
the graphical user interface displays the video, a map with the geographic position of the unmanned aerial vehicle, and the altitude of the unmanned aerial vehicle.

15. The device of claim 11, wherein the one or more processors are further configured to collectively:
receive, from the observer computing device via the communications interface, digitized voice of the observer at the observer computing device; and
output the digitized voice of the observer to the surface-based pilot.

16. The device of claim 11, wherein the one or more processors are further configured to collectively:
receive, from the observer computing device via the communications interface, a command to control a camera of the unmanned aerial vehicle; and
output the command to control a camera to the surface-based pilot or the unmanned aerial vehicle.

17. The device of claim 11, wherein the graphical user interface is configured for inspection of infrastructure by the observer at the observer computing device.

18. A method comprising:
receiving flight data of an unmanned aerial vehicle that is controllable by a surface-based pilot with a remote control;
generating a graphical user interface with the flight data; and
outputting the graphical user interface to an observer computing device that is remote from the surface-based pilot with the remote control, wherein the graphical user interface provides the flight data to an observer at the observer computing device.

19. The method of claim 18, wherein:
the flight data comprises video captured by a camera of the unmanned aerial vehicle and a position of the unmanned aerial vehicle; and
the method further comprises displaying the video and the position of the unmanned aerial vehicle within the graphical user interface.

20. The method of claim 18, further comprising:
receiving feedback data from the observer computing device; and
outputting the feedback data to the surface-based pilot or the unmanned aerial vehicle.
